(19) United States
(12) Patent Application Publication
(10) Pub. No.: US 2025/0110987 A1
(43) Pub. Date: Apr. 3, 2025

(54) SOUND ESTIMATING MODEL ACQUIRING APPARATUS, SOUND ESTIMATING APPARATUS, SOUND ESTIMATING MODEL ACQUIRING METHOD, SOUND ESTIMATING METHOD AND PROGRAM

(71) Applicant: NIPPON TELEGRAPH AND TELEPHONE CORPORATION, Tokyo (JP)

(72) Inventors: Daiki TAKEUCHI, Musashino-shi (JP); Yasunori OISHI, Musashino-shi (JP); Daisuke NIIZUMI, Musashino-shi (JP); Noboru HARADA, Musashino-shi (JP); Kunio KASHINO, Musashino-shi (JP)

(73) Assignee: NIPPON TELEGRAPH AND TELEPHONE CORPORATION, Tokyo (JP)

(21) Appl. No.: 18/728,555

(22) PCT Filed: Jul. 4, 2022
(86) PCT No.: PCT/JP2022/026609

§ 371 Date: Jul. 12, 2024

(30) Foreign Application Priority Data
Jan. 17, 2022 (WO) PCT/JP2022/001272

(51) Int. Cl. G06F 16/635; G10L 25/51

(52) U.S. Cl. CPC G06F 16/635; G10L 25/51

(57) ABSTRACT

According to an aspect of the present invention, there is provided a sound estimation model acquisition device including a model acquisition unit configured to acquire a mathematical model that estimates an estimated time series that is a time series satisfying a predetermined estimation condition from one or a plurality of time series on a basis of a first sound time series that is a time series indicating a first sound, a second sound time series that is a time series indicating a second sound, and first difference information indicating at least a partial difference between the first sound and the second sound, in which the mathematical model is a mathematical model that estimates the estimated time series on the basis of an input time series that is a time series indicating an input sound and second difference information that is information indicating at least a partial difference between the input time series and the estimated time series, and the estimation condition is a condition that a difference between a difference from the input time series and a difference indicated by the second difference information is smaller than a predetermined difference.

### TECHNICAL FIELD

The present invention relates to a sound estimating model acquiring apparatus, a sound estimating apparatus, a sound estimating model acquiring method, a sound estimating method and a program.

### BACKGROUND ART

The time series of sounds available on the Internet and the like, such as audio signals available on the Internet and the like, is increasing every day, and a method of retrieving a target audio signal from a database of a large number of audio signals is absolutely necessary. Most of the methods proposed so far are roughly divided into two methods: a method of using a text as a query and a method of using an audio signal as a query.

In the method of using a text as a query, data in which two of an audio signal and a text describing the audio signal are paired is used. In the method of using a text as a query, the learning is performed for a common latent space between the audio signal and the text by using the data, and an audio signal having an embedded representation similar to the embedded representation of the input text query is retrieved.

The method of using an audio signal as a query is also referred to as a method based on a content. In this method, the audio signal having a representation similar to the embedded representation of the input audio signal query is retrieved.

### CITATION LIST

### Non Patent Literature

Non Patent Literature 1: P. Manocha, R. Badlani, A. Kumar, A. Shah, B. Elizalde, and B. Raj, “Content-based representations of audio using siamese neural networks”, in Proc. IEEE Int. Conf. Acoust. Speech Signal Process. (ICASSP). IEEE, 2018, pp. 3136-3140.

### SUMMARY OF INVENTION

### Technical Problem

Since the text query can be easily edited manually, the retrieval range can be flexibly adjusted in the method of using a text as a query. However, since it is not easy to completely describe the content of the audio signal only with a text, there is a possibility of the rough retrieval. As a result, the accuracy of estimation of the audio signal may be low.

In the method of using an audio signal as a query, information that cannot be expressed by a text can also be used as a query in the form of an audio signal. Therefore, it is possible to set the retrieval range in more detail than the method of using a text as a query. On the other hand, since the retrieval range is mainly set for the embedding of the audio signal query, and it is not easy to edit the audio signal, it may be difficult to flexibly adjust the retrieval range. As a result, the accuracy of estimation of the audio signal may be low.

Such circumstances are common not only to the audio signal but also to time series of sounds such as sound signals.

In view of the above circumstances, an object of the present invention is to provide a technique for improving the accuracy of estimation of a time series indicating a sound.

### Solution to Problem

According to an aspect of the present invention, there is provided a sound estimation model acquisition device including a model acquisition unit configured to acquire a mathematical model that estimates an estimated time series that is a time series satisfying a predetermined estimation condition from one or a plurality of time series on the basis of a first sound time series that is a time series indicating a first sound, a second sound time series that is a time series indicating a second sound, and first difference information indicating at least a partial difference between the first sound and the second sound, in which the mathematical model is a mathematical model that estimates the estimated time series on the basis of an input time series that is a time series indicating an input sound and second difference information that is information indicating at least a partial difference between the input time series and the estimated time series, and the estimation condition is a condition that a difference between a difference from the input time series and a difference indicated by the second difference information is smaller than a predetermined difference.

According to another aspect of the present invention, there is provided a sound estimation device including: a query acquisition unit configured to acquire query information including a sound time series that is a time series indicating a sound and second difference information indicating at least a partial difference between an estimated time series that is a time series satisfying a predetermined estimation condition and the sound time series; and an estimation unit configured to estimate a time series satisfying the estimation condition from one or a plurality of time series on the basis of the query information acquired by the query acquisition unit, by using a mathematical model acquired by a sound estimation model acquisition device including a model acquisition unit configured to acquire the mathematical model that estimates a time series satisfying the estimation condition from one or a plurality of time series on the basis of a first sound time series that is a time series indicating a first sound, a second sound time series that is a time series indicating a second sound, and first difference information indicating at least a partial difference between the first sound and the second sound, the mathematical model being a mathematical model that estimates a time series satisfying the estimation condition on the basis of an input time series that is a time series indicating an input sound and second difference information that is information indicating at least a partial difference between the input time series and a time series satisfying the estimation condition, and the estimation condition being a condition that a difference between a difference from the input time series and a difference indicated by the second difference information is smaller than a predetermined difference.

According to still another aspect of the present invention, there is provided a sound estimation model acquisition method including a sound estimation model acquisition step of acquiring a mathematical model that estimates an estimated time series that is a time series satisfying a predetermined estimation condition from one or a plurality of time series on the basis of a first sound time series that is a time series indicating a first sound, a second sound time series that is a time series indicating a second sound, and first difference information indicating at least a partial difference between the first sound and the second sound, in which the mathematical model is a mathematical model that estimates the estimated time series on the basis of an input time series that is a time series indicating an input sound and second difference information that is information indicating at least a partial difference between the input time series and the estimated time series, and the estimation condition is a condition that a difference between a difference from the input time series and a difference indicated by the second difference information is smaller than a predetermined difference.

According to still another aspect of the present invention, there is provided a sound estimation method including: a query acquisition step of acquiring query information including a sound time series that is a time series indicating a sound and second difference information indicating at least a partial difference from an estimated time series that is a time series satisfying a predetermined estimation condition; and an estimation step of estimating a time series satisfying the estimation condition from one or a plurality of time series on the basis of the query information acquired in the query acquisition step, by using a mathematical model acquired by a sound estimation model acquisition device including a model acquisition unit configured to acquire the mathematical model that estimates a time series satisfying the estimation condition from one or a plurality of time series on the basis of a first sound time series that is a time series indicating a first sound, a second sound time series that is a time series indicating a second sound, and first difference information indicating at least a partial difference between the first sound and the second sound, the mathematical model being a mathematical model that estimates a time series satisfying the estimation condition on the basis of an input time series that is a time series indicating an input sound and second difference information that is information indicating at least a partial difference between the input time series and a time series satisfying the estimation condition, and the estimation condition being a condition that a difference between a difference from the input time series and a difference indicated by the second difference information is smaller than a predetermined difference.

According to still another aspect of the present invention, there is provided a program for causing a computer to function as the above-described sound estimation model acquisition device.

According to still another aspect of the present invention, there is provided a program for causing a computer to function as the above-described sound estimation device.

### Advantageous Effects of Invention

According to the present invention, it is possible to improve the accuracy of estimation of the time series indicating a sound.

### BRIEF DESCRIPTION OF DRAWINGS

FIG. 1 is an explanatory diagram illustrating an outline of a sound estimation system according to an embodiment.

FIG. 2 is an explanatory diagram illustrating an example of processing of machine learning according to the embodiment.

FIG. 3 is a diagram illustrating an example of a hardware configuration of a sound estimation model acquisition device according to the embodiment.

FIG. 4 is a diagram illustrating an example of a functional configuration of a control unit included in a sound estimation model acquisition device according to the embodiment.

FIG. 5 is a flowchart illustrating an example of a flow of processing executed by a sound estimation model acquisition device according to the embodiment.

FIG. 6 is a diagram illustrating an example of a hardware configuration of a sound estimation device according to the embodiment.

FIG. 7 is a diagram illustrating an example of a functional configuration of a control unit included in a sound estimation device according to the embodiment.

FIG. 8 is a flowchart illustrating an example of a flow of processing executed by a sound estimation device according to the embodiment.

FIG. 9 is a first diagram illustrating an example of an experimental result according to the embodiment.

FIG. 10 is a second diagram illustrating an example of an experimental result according to the embodiment.

FIG. 11 is a third diagram illustrating an example of an experimental result according to the embodiment.

FIG. 12 is a diagram illustrating an example of a configuration of a training network according to a modification example.

### DESCRIPTION OF EMBODIMENTS

### Embodiment

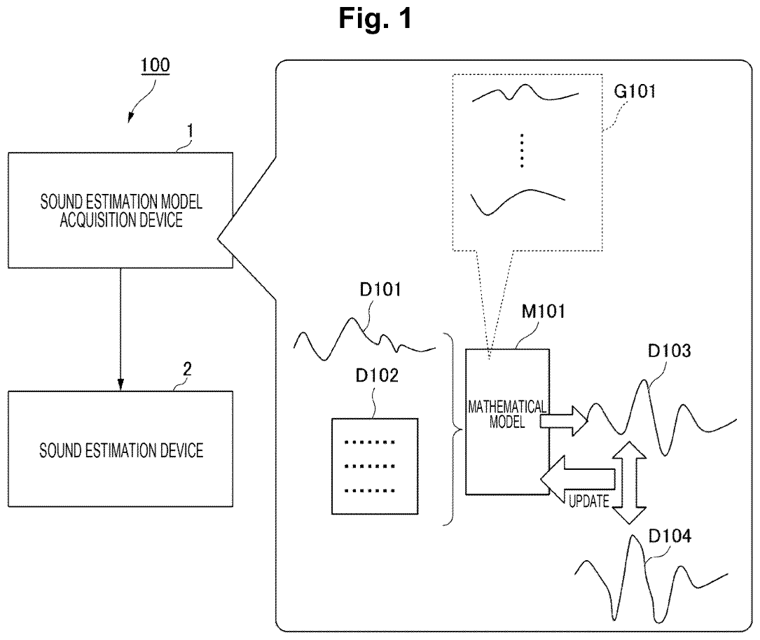

FIG. 1 is an explanatory diagram illustrating an outline of a sound estimation system 100 according to an embodiment. The sound estimation system 100 includes a sound estimation model acquisition device 1 and a sound estimation device 2.

The sound estimation model acquisition device 1 acquires a sound estimation model on the basis of a first sound time series that is a time series indicating a first sound, a second sound time series that is a time series indicating a second sound, and first difference information indicating at least a partial difference between the first sound and the second sound.

The first difference information is, for example, text data. In a case where the first difference information is text data, the text indicated by the first difference information is, for example, a text with “Add the sound of thunder”.

The first difference information may be, for example, image data. In a case where the first difference information is image data, an image indicated by the first difference information is, for example, an image of thunder.

The sound estimation model is a mathematical model that estimates a time series satisfying an estimation condition (hereinafter, referred to as “estimated time series”) from one or a plurality of time series given in advance. The estimation condition is a condition that a difference between a difference from an input time series and a difference indicated by second difference information is smaller than a predetermined difference. For example, the estimation condition is a condition that the difference from the input time series is closest to the difference indicated by the second difference information.

The input time series is a time series input to the sound estimation model and is a time series indicating a sound. Hereinafter, the time series indicating the sound is referred to as a sound time series. The input time series can be said to be a sound time series input to the sound estimation model. The second difference information is information indicating at least a partial difference between the input time series and the estimated time series.

Since the second difference information is information indicating at least a partial difference between the input time series and the estimated time series, the second difference information input to the sound estimation model may be, for example, information indicating a partial difference between the input time series and the estimated time series.

For example, in a case where the first difference information is text data, the second difference information is text data. For example, in a case where the first difference information is image data, the second difference information is image data.

The sound estimation model acquisition device 1 acquires a sound estimation model by, for example, machine learning. More specifically, the sound estimation model acquisition device 1 updates the sound estimation model by machine learning until a predetermined end condition regarding training (hereinafter, referred to as a “training end condition”) is satisfied, and thus acquires a sound estimation model with higher estimation accuracy than before the training end condition is satisfied.

In the machine learning, for example, processing of updating the sound estimation model so as to reduce the difference between the time series estimated by the sound estimation model and the second sound time series on the basis of the first sound time series and the first difference information. In this manner, the estimation accuracy of the sound estimation model is increased by machine learning.

The sound estimation model at the time point when the training end condition is satisfied is a sound estimation model obtained by the sound estimation model acquisition device 1 on the basis of the first sound time series, the second sound time series, and the first difference information. Hereinafter, the sound estimation model at the time point when the training end condition is satisfied is referred to as a trained sound estimation model. The trained sound estimation model is one type of sound estimation model.

FIG. 1 also illustrates an outline of processing of obtaining a trained sound estimation model by machine learning. A model M101 illustrated in FIG. 1 is an example of a sound estimation model before the training end condition is satisfied. A group G101 is an example of a group of time series candidates that can be estimated to be the estimated time series by the model M101. The time series belonging to the group G101 is a time series indicating a sound. Information D101 is an example of the first sound time series, and information D102 is an example of the first difference information.

Information D103 illustrated in FIG. 1 is an example of a result of estimation of the model M101. That is, the information D103 is an example of the time series estimated to be the estimated time series by the model M101 among the time series belonging to the Group G101. Information D104 illustrated in FIG. 1 is an example of the second sound time series. FIG. 1 illustrates that the model M101 is updated such that a difference between the estimation result of the model M101 (that is, the information D103) and the information D104 becomes small.

<More detailed example of training>

Here, a more detailed example of training will be described. In the training stage, the sound estimation model converts the first sound time series into a vector (hereinafter, referred to as a “first sound vector”) representing the first sound time series. In the training stage, the sound estimation model converts the second sound time series into a vector (hereinafter, referred to as a “second sound vector”) representing the second sound time series. In the training stage, the sound estimation model converts a first difference time series into a vector (hereinafter, referred to as a “first difference vector”) representing the first difference time series.

In the training stage, the sound estimation model estimates the time series satisfying an estimation condition among the time series belonging to the group G101 on the basis of the first sound vector and the first difference vector. In the training stage, the sound estimation model is updated so as to reduce the difference between a vector representing the estimated time series and the second sound vector.

The difference may be represented by any index as long as the index indicates a distance between the vectors in a vector space representing the second sound vector. The distance between the vectors is represented by, for example, an inner product between the vectors. The distance between the vectors is represented by, for example, a cosine similarity between the vectors.

The distance between the vectors may be represented by, for example, Expression (1), Expression (2), or Expression (3) below. Expressions (1) to (3) below are Expressions indicating the definition of a distance between a vector x and a vector y.

$$[ Math . 1 ]$$

$${d}_{cossim} ( x , y ) = \frac{xy}{{‖ x ‖}_{2} {‖ y ‖}_{2}} \qquad ( 1 )$$

$$[ Math . 2 ]$$

$${d}_{innerprod} ( x , y ) = xy \qquad ( 2 )$$

$$[ Math . 3 ]$$

$${d}_{euc} ( x , y ) = {‖ x - y ‖}_{2} \qquad ( 3 )$$

$$Note that {‖ \cdot ‖}_{2} means an L 2 - norm .$$

Specifically, the updating of the sound estimation model includes updating of the content of embedding processing of converting the first sound time series into the first sound vector. Specifically, the updating of the sound estimation model includes updating of the content of embedding processing of converting the second sound time series into the second sound vector. Specifically, the updating of the sound estimation model includes updating of the content of embedding processing of converting the first difference time series into the first difference vector.

Such updating will be described by a mathematical Expression. The updating means, for example, updating the mapping F_{q} or mapping Fₜ in processing represented by Expression (4) below so as to satisfy a condition represented by Expression (4) below.

$$[ Math . 4 ]$$

$${min}_{b} d ( {F}_{q} ( a , t ) , {F}_{t} ( b ) ) \qquad ( 4 )$$

a means the first sound time series, and t means the first difference time series. b means the second sound time series. The mapping F_{q} represents processing executed for the estimated time series estimated by the sound estimation model on the basis of a set of a first argument and a second argument, and processing of obtaining a vector representing the estimated time series.

The mapping Fₜ represents processing of obtaining a vector representing the sound time series indicated by the first argument. Mapping d means processing of obtaining a distance in a vector space between the vector indicated by the first argument and the vector indicated by the second argument. Therefore, the mapping d represents processing of obtaining an inner product of the vector indicated by the first argument and the vector indicated by the second argument. Expression (1) means that the updating is performed so as to minimize a distance d.

Specifically, the mapping F_{q} is represented by, for example, Expression (5) below.

$$[ Math . 5 ]$$

$${F}_{q} ( a , t ) = A ( a ) + T ( t ) \qquad ( 5 )$$

Mapping A represents processing of converting the sound time series of the first argument into the first sound vector. The mapping T represents processing of converting a first difference time series t into the first difference vector.

Specifically, the mapping Fₜ is represented by, for example, Expression (6) below.

$$[ Math . 6 ]$$

$${F}_{t} ( b ) = A ( b ) \qquad ( 6 )$$

In the example of Expression (6), the image of the mapping F_{q} is expressed as a result obtained by adding the image of the mapping T to the image of the mapping A. However, the image of the mapping F_{q} does not necessarily need to be expressed as a result obtained by addition as long as the image of the mapping Fq is expressed by the result of the binary operation on the image of the mapping A and the image of the mapping T as represented by Expression (7). The image of the mapping F_{q} may be expressed as, for example, an image represented by the Expression (8) below.

$$[ Math . 7 ]$$

$${F}_{q} ( a , t ) = f ( A ( a ) , T ( t ) ) \qquad ( 7 )$$

$$[ Math . 8 ]$$

$${F}_{q} ( a , t ) = A ( a ) * T ( t ) \qquad ( 8 )$$

The mapping f in Expression (7) represents a binary operation on the first argument and the second argument. * in Expression (8) means acquisition of a product (that is, Hadamard product) for each element.

As described above, in the training stage, the sound estimation model is updated so as to reduce the difference between a vector representing the estimated time series and the second sound vector. Therefore, for example, in the training of the sound estimation model, the first difference vector is added to the first sound vector, and the sound time series having a feature vector closest to the addition result is output. As described above, in the training of the sound estimation model, the sound estimation model is updated so as to reduce the difference between a vector representing the output sound time series and the second sound vector.

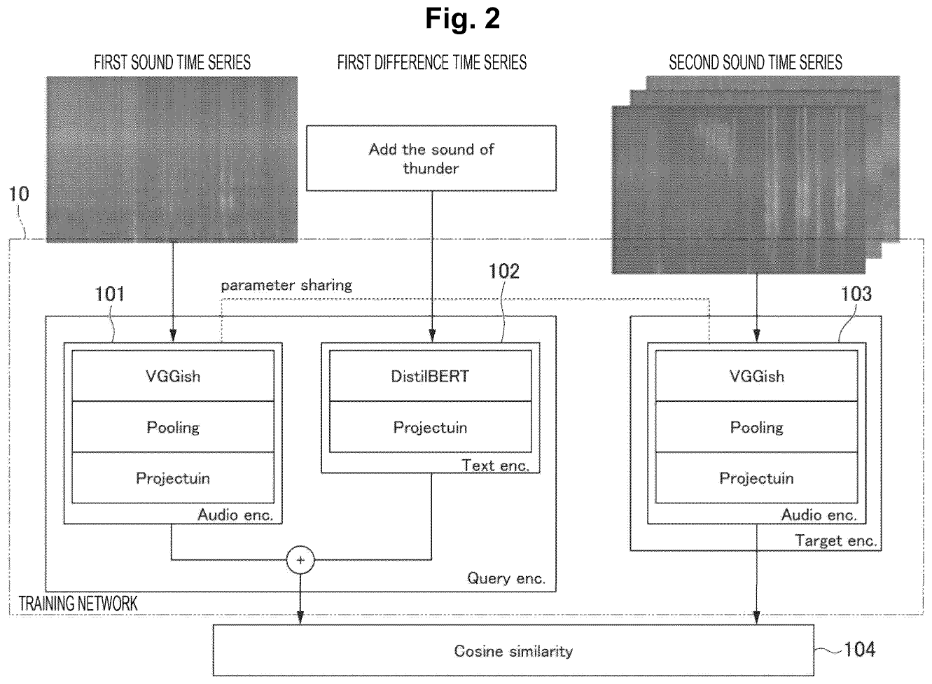

FIG. 2 is an explanatory diagram illustrating an example of processing of the machine learning according to the embodiment. More specifically, FIG. 2 is a diagram illustrating an example of a training network 10 that is a neural network for training the sound estimation model.

The training network 10 includes a first encoder 101, a second encoder 102, and a third encoder 103.

The first encoder 101 is an encoder in which a processing content is represented by the mapping A and to which the first sound time series is input. The second encoder 102 is an encoder in which a processing content is represented by the mapping T and to which the first difference information is input. The third encoder 103 is an encoder in which a processing content is represented by the mapping A and to which the second sound time series is input.

The first encoder 101 and the third encoder 103 are neural networks including a layer that executes VGGish, a layer that executes pooling, and a layer that executes projection. The second encoder 102 is a neural network having a layer that executes DistiBERT and a layer that executes projection.

In the example of FIG. 2, training of the first encoder 101, the third encoder 103, and the second encoder 102 is performed by, for example, cross-modal contrast training. In FIG. 2, the distance between the vectors used in the training is represented by, for example, Expression (9) below.

$$[ Math . 9 ]$$

$${min}_{b} {d}_{cossim} ( A ( a ) + T ( t ) , A ( b ) ) \qquad ( 9 )$$

The training network 10 is updated by an update unit 104. The update unit 104 calculates a value of a loss function on the basis of the output of the training network 10. The update unit 104 updates the training network 10 on the basis of the calculated value of the loss function. The loss function in the example of FIG. 2 is, for example, a cosine similarity represented by Expression (10) below.

$$[ Math . 10 ]$$

$$L = - \frac{1}{2} ( {\sum }_{n} log \frac{{e}^{{x}_{n , n}}}{{\sum }_{k} {e}^{{z}_{n , k}}} + {\sum }_{n} log \frac{{e}^{{z}_{n , n}}}{{\sum }_{k} {e}^{{z}_{k , n}}} ) \qquad ( 10 )$$

$$[ Math . 11 ]$$

$${z}_{i , j} = {d}_{cossim} ( A ( {a}_{i} ) + T ( {t}_{i} ) , A ( {b}_{i} ) ) \cdot {e}^{τ} \qquad ( 11 )$$

Note that t represents a temperature parameter. The value of the temperature parameter t may be zero. Note that i and j are indexes in a batch.

Note that in the example of FIG. 2, the parameter values of the VGGish and DistilBERT are fixed, and the parameter values of the VGGish and DistilBERT may not be updated by training. In such a case, in the updating of the contents of the mapping A and mapping T, for example, the parameter value of the projection is updated by training, and the parameter values of the VGGish and DistilBERT are not updated.

The description returns to FIG. 1. The sound estimation device 2 estimates the estimated time series on the basis of query information by using the sound estimation model obtained by the sound estimation model acquisition device 1. The query information includes a query time series that is a sound time series input to the sound estimation device 2 and query difference information. The query difference information is second difference information indicating at least a partial difference between the estimated time series and the query time series.

Note that the sound estimation model used by the sound estimation device 2 is a trained sound estimation model in a case where the sound estimation model acquisition device 1 acquires the sound estimation model by machine learning. Note that the sound time series input to the sound estimation device 2 is input to the sound estimation model. Therefore, the query time series is also a sound time series input to the sound estimation model.

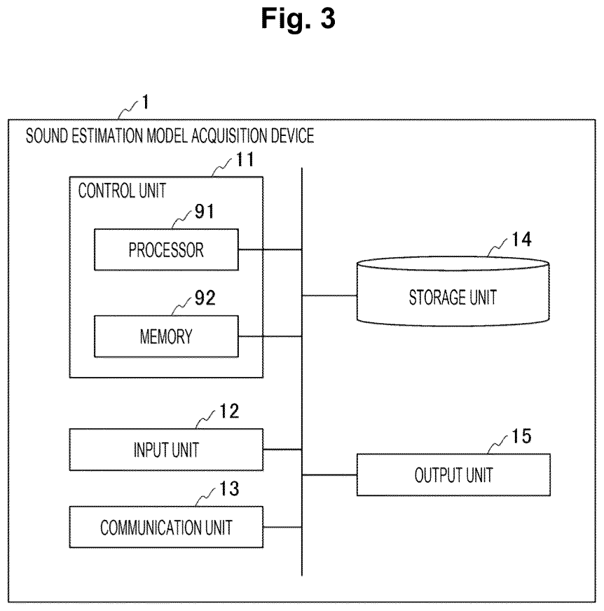

FIG. 3 is a diagram illustrating an example of a hardware configuration of the sound estimation model acquisition device 1 according to the embodiment. The sound estimation model acquisition device 1 includes a control unit 11 including a processor 91 such as a central processing unit (CPU) and a memory 92, which are connected to each other by a bus, and executes a program. The sound estimation model acquisition device 1 functions as a device including the control unit 11, an input unit 12, a communication unit 13, a storage unit 14, and an output unit 15 by executing the program.

More specifically, in the sound estimation model acquisition device 1, the processor 91 reads the program stored in the storage unit 14, and stores the read program in the memory 92. When the processor 91 executes the program stored in the memory 92, the sound estimation model acquisition device 1 functions as the device including the control unit 11, the input unit 12, the communication unit 13, the storage unit 14, and the output unit 15.

The control unit 11 controls operations of various functional units included in the sound estimation model acquisition device 1. The control unit 11 performs, for example, processing of acquiring the sound estimation model.

The input unit 12 includes, for example, input devices such as a mouse, a keyboard, and a touch panel. The input unit 12 may include an interface that connects these input devices to the sound estimation model acquisition device 1.

The communication unit 13 includes an interface for connecting the sound estimation model acquisition device 1 to an external device. The communication unit 13 communicates with the external device in a wired or wireless manner. The external device is, for example, a transmission source device of a set of the first sound time series, first difference information, and second sound time series. The communication unit 13 acquires a set of the first sound time series, first difference information, and second sound time series by communication with the transmission source device of a set of the first sound time series, first difference information, and second sound time series. The external device is, for example, the sound estimation device 2. The communication unit 13 transmits the sound estimation model to the sound estimation device 2 by communication with the sound estimation device 2.

The storage unit 14 is configured using a computer-readable storage medium device such as a magnetic hard disk device or a semiconductor storage device. The storage unit 14 stores various types of information related to the sound estimation model acquisition device 1. The storage unit 14 stores, for example, various types of information generated as a result of processing executed by the control unit 11. For example, the storage unit 14 stores, in advance, one or a plurality of time series that are candidates for the estimated time series, such as time series belonging to the group G101.

The output unit 15 includes, for example, a display device such as a cathode ray tube (CRT) display, a liquid crystal display, or an organic electro-luminescence (EL) display. The output unit 15 may include an interface that connects these display devices to the sound estimation model acquisition device 1.

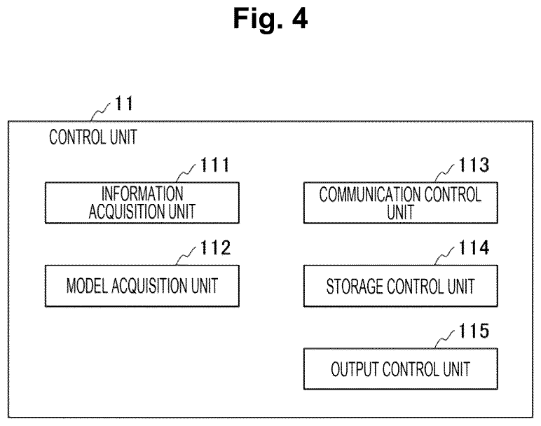

FIG. 4 is a diagram illustrating an example of a functional configuration of the control unit 11 included in the sound estimation model acquisition device 1 according to the embodiment. The control unit 11 includes an information acquisition unit 111, a model acquisition unit 112, a communication control unit 113, a storage control unit 114, and an output control unit 115.

The information acquisition unit 111 acquires data that is input to the communication unit 13. The information acquisition unit 111 acquires, for example, the first sound time series, the first difference information, and the second sound time series.

The model acquisition unit 112 acquires a sound estimation model by using one or a plurality of sets of the first sound time series, first difference information, and second sound time series. The model acquisition unit 112 includes, for example, the training network 10 and the update unit 104. In such a case, the model acquisition unit 112 obtains a trained sound estimation model by updating the training network 10 by machine learning until the training end condition is satisfied.

The communication control unit 113 controls the operation of the communication unit 13. The storage control unit 114 controls the operation of the storage unit 14. The output control unit 115 controls the operation of the output unit 15.

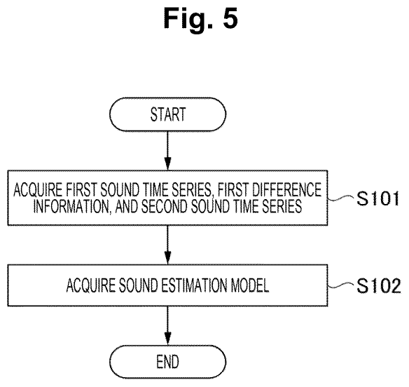

FIG. 5 is a flowchart illustrating an example of a flow of processing executed by the sound estimation model acquisition device 1 according to the embodiment. The information acquisition unit 111 acquires, for example, one or a plurality of sets of the first sound time series, first difference information, and second sound time series (step S101). Next, the model acquisition unit 112 acquires a sound estimation model by using sets of the first sound time series, first difference information, and second sound time series which are acquired by the information acquisition unit 111 (step S102).

The sound estimation model obtained in this manner is used by the sound estimation device 2.

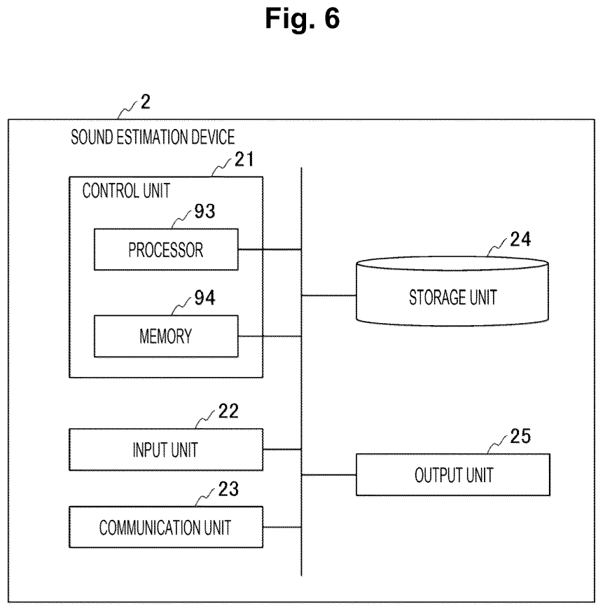

FIG. 6 is a diagram illustrating an example of a hardware configuration of the sound estimation device 2 according to the embodiment. The sound estimation device 2 includes a control unit 21 including a processor 93 such as a CPU and a memory 94, which are connected to each other via a bus, and executes a program. When the program is executed, the sound estimation device 2 functions as a device including the control unit 21, an input unit 22, a communication unit 23, a storage unit 24, and an output unit 25.

More specifically, in the sound estimation device 2, the processor 93 reads the program stored in the storage unit 24, and stores the read program in the memory 94. When the processor 93 executes the program stored in the memory 94, the sound estimation device 2 functions as a device including the control unit 21, the input unit 22, the communication unit 23, the storage unit 24, and the output unit 25.

The control unit 21 controls operations of various functional units included in the sound estimation device 2. The control unit 21 executes, for example, the sound estimation model. The sound estimation model executed by the control unit 21 is, for example, a trained sound estimation model.

The input unit 22 includes, for example, input devices such as a mouse, a keyboard, and a touch panel. The input unit 22 may include an interface that connects these input devices to the sound estimation device 2. For example, a set of the query time series and query difference information is input to the input unit 22.

The communication unit 23 includes an interface for connecting the sound estimation device 2 to an external device. The communication unit 23 communicates with the external device in a wired or wireless manner. The external device is, for example, a transmission source device of query information. The communication unit 23 acquires the query information by communication with the transmission source device of the query information.

The external device is, for example, the sound estimation model acquisition device 1. The communication unit 23 acquires a sound estimation model by communication with the sound estimation model acquisition device 1. The sound estimation model obtained by the communication unit 23 by communication with the sound estimation model acquisition device 1 is, for example, a trained sound estimation model.

The storage unit 24 is configured using a computer-readable storage medium device such as a magnetic hard disk device or a semiconductor storage device. The storage unit 24 stores various types of information related to the sound estimation device 2. The storage unit 24 stores, for example, various types of information generated as a result of processing executed by the control unit 21. For example, the storage unit 24 stores, in advance, one or a plurality of time series that are candidates for the estimated time series.

The output unit 25 includes, for example, a display device such as a CRT display, a liquid crystal display, or an organic EL display. The output unit 25 may include an interface that connects these display devices to the sound estimation device 2.

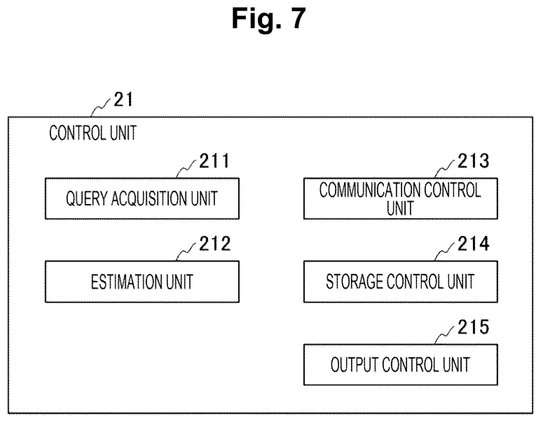

FIG. 7 is a diagram illustrating an example of a functional configuration of the control unit 21 included in the sound estimation device 2 according to the embodiment. The control unit 21 includes a query acquisition unit 211, an estimation unit 212, a communication control unit 213, a storage control unit 214, and an output control unit 215.

The query acquisition unit 211 acquires query information input to the communication unit 23.

The estimation unit 212 executes the sound estimation model with respect to the query information acquired by the query acquisition unit 211. The estimation unit 212 estimates the time series satisfying the estimation condition from one or a plurality of time series stored in advance in the storage unit 24 by executing the sound estimation model with respect to the query information. The sound estimation model executed by the estimation unit 212 is, for example, a trained sound estimation model.

The communication control unit 213 controls the operation of the communication unit 23. The storage control unit 214 controls the operation of the storage unit 24. The output control unit 215 controls the operation of the output unit 25.

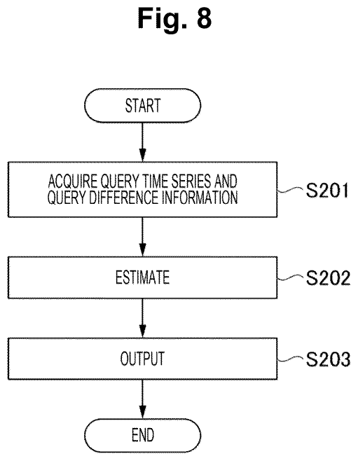

FIG. 8 is a flowchart illustrating an example of a flow of processing executed by the sound estimation device 2 according to the embodiment. The query acquisition unit 211 acquires query information (step S201). Next, the estimation unit 212 executes the sound estimation model with respect to the query information acquired in step S201 (step S202). After step S202, the output control unit 215 causes the output unit 25 to output an estimation result of the estimation unit 212 by controlling the operation of the output unit 25 (step S203).

### <Experimental Result>

An example of a result of constructing an Audio Pair with Difference (APwD) data set and verifying the effect of the sound estimation system 100 will be described. Specifically, the sound estimation system 100 used in the experiment was the sound estimation system 100 that includes the training network 10 and the update unit 104 in FIG. 2 and obtains a sound estimation model by machine learning.

The APwD data set was a data set synthesized using audio files of FSD 50k and ESC-50, which are data sets for audio tagging, and was a data set in which three sets of pairs of similar but different audio signals and texts describing the differences were formed.

In the experiment, two scenes of Rain and Traffic were prepared in the APwD data set. In the Rain scene, data labeled with “rain” in the FSD 50k as the background sound and data labeled with “dog”, “chirping_bird”, “thunder”, and “footsteps” in the ESC-50 as an event sound were used for synthesis.

In the Traffic scene, data labeled with “car_passing” in the FSD 50k as the background sound and data labeled with “dog”, “chirping_bird”, “car_horn”, and “church_bell” in the ESC-50 as the event sound were used for synthesis. In each of the two scenes, 50000 pairs of training sets and 1000 pairs of evaluation sets were prepared and used for the experiment.

Furthermore, in order to confirm whether or not the model can apply a combination of a background sound and an event sound, which are not included in the training set, synthesis was also performed for two scenes of Rain with unknown events and Traffic with unknown events, which include an event sound that is such a combination.

In these examples, data labeled with “rain” or “car_passing” in the FSD 50k was used as the background sound. Furthermore, data labeled with “dog”, “chirping_bird”, “thunder”, “footsteps”, “car_horn”, and “church_bell” in the ESC-50 as the event sound was used for synthesis. In these two scenes, only 1000 pairs of evaluation sets were prepared.

In the experiment, training was performed with three pieces of data of Rain-tr, Traffic tr, and Both tr, and evaluation results were compared. The Rain-tr includes 50000 pairs of training sets of Rain scenes. The Traffic-tr includes 50000 pairs of training sets of Traffic scenes. The Both-tr includes 25000 pairs included in the training set of the Rain scene and 25000 pairs included in the training set of the Traffic scene.

In the training, 10% of each training set was utilized as a verification set. In optimization, optimization using Adam was performed 300 epochs, and a model having the smallest value of the loss function in the verification set was used for evaluation.

Recall@K was used in the evaluation. Recall@K is a ratio at which a correct candidate is included in the top K retrieval candidates. Furthermore, as a technique of a baseline to be compared with the sound estimation system 100, a technique (hereinafter, referred to as a “technique to be compared”) in which an encoder portion (that is, the second encoder 102) of a text is removed from the sound estimation system 100 was used.

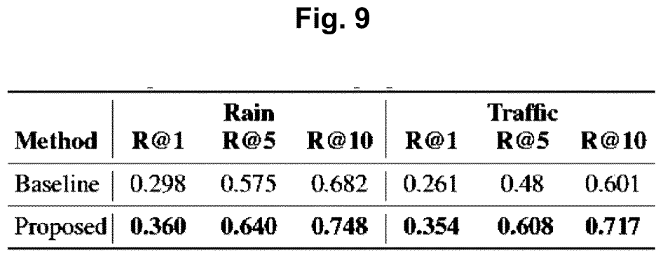

FIG. 9 is a first diagram illustrating an example of an experimental result according to the embodiment. More specifically, FIG. 9 illustrates a result of evaluating models trained using Rain-tr and Traffic tr with the evaluation set of Rain and the evaluation set of Traffic, respectively. A row of “Proposed” in FIG. 9 indicates a result of evaluating the sound estimation system 100. A row of “Baseline” in FIG. 9 indicates a result of evaluating the technique to be compared.

The results in FIG. 9 show that the estimation accuracy of the sound estimation system 100 exceeds the estimation accuracy of the technique to be compared under all conditions. Therefore, FIG. 9 illustrates that the first difference information and the second difference information are used, and thus the estimation accuracy is improved. Note that the first difference information and the second difference information in the experiment are pieces of data expressed by text data.

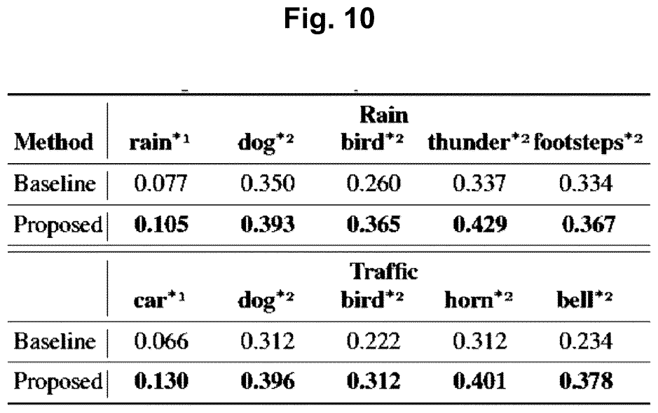

FIG. 10 is a second diagram illustrating an example of an experimental result according to the embodiment. More specifically, FIG. 10 illustrates a result of comparing Recall@1 for each event having a difference in the Recall@1. The results in FIG. 10 show that the estimation accuracy of the sound estimation system 100 exceeds the estimation accuracy of the technique to be compared.

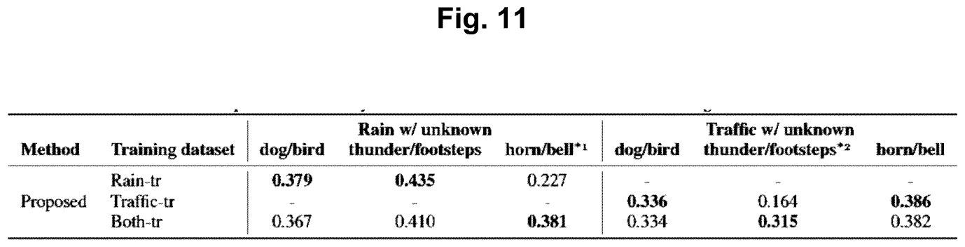

FIG. 11 is a third diagram illustrating an example of an experimental result according to the embodiment. Specifically, FIG. 11 is a diagram illustrating an example of an experimental result of an experiment for confirming whether the model can apply a combination of a background sound and an event sound, which are not included in the training set in the sound estimation system 100. In the experiment for obtaining the result of FIG. 11, a Rain-tr model, a Traffic-tr model, and a Both-tr model were evaluated with the evaluation sets of Rain with unknown events and Traffic with unknown events.

The Rain-tr model is a mathematical model obtained by training using the Rain-tr. The Traffic-tr model is a mathematical model obtained by training using the Traffic-tr. The Both-tr model is a mathematical model obtained by training using the Both-tr.

Each value in FIG. 11 indicates Recall@1, and “*1” in FIG. 11 indicates an event sound that is not included in the Rain scene. “*2” in FIG. 11 indicates an event sound that is not included in the Traffic scene.

FIG. 11 illustrates that, among the evaluation results of the models respectively obtained by the training using Rain-tr and Traffic-tr, the evaluation result of car_horn or church_bell in Rain with unknown events and the evaluation result of thunder or footsteps in Traffic with unknown events are lower than the results of the other evaluations.

Car_horn or church_bell in Rain with unknown events and thunder or footsteps in Traffic with unknown events are information not included in each scene.

On the other hand, FIG. 11 illustrates that such a decrease in evaluation is greatly reduced in the model obtained by training using the Both-tr. Therefore, FIG. 11 illustrates that in the sound estimation system 100, audio retrieval can be performed by applying a difference obtained by separating information regarding the difference from the background sound and performing learning of the information to various background sounds.

The sound estimation model acquisition device 1 configured as described above acquires the sound estimation model by using the first difference data. Therefore, the sound estimation model acquisition device 1 can improve the accuracy of estimation of the time series indicating a sound.

Furthermore, the sound estimation device 2 configured as described above estimates the estimation target by using the mathematical model obtained by the sound estimation model acquisition device 1. Therefore, the sound estimation device 2 can improve the accuracy of estimation of the time series indicating a sound.

### Modification Example

Note that the sound estimation model acquisition device 1 may acquire the sound estimation model on the basis of a first sound event class label and a second sound event class label in addition to the first sound time series, the second sound time series, and the first difference information. That is, the model acquisition unit 112 may acquire the sound estimation model on the basis of a first sound event class label and a second sound event class label in addition to the first sound time series, the second sound time series, and the first difference information. The first sound event class label indicates a classification result of the first sound time series by processing of predetermined classification. The second sound event class label indicates a classification result of the second sound time series by classification processing similar to the classification processing on the first sound time series. The predetermined classification processing may be any classification processing as long as it is processing of classifying the sound time series as a classification target and is processing of classifying the classification targets by a method of being capable of classifying the sound time series.

The predetermined classification processing may be, for example, processing of classifying the first sound time series or the second sound time series according to the sound recognized to be included by the user when the user hears the sound indicated by the sound time series to be classified. When the user hears the sound indicated by the sound time series to be classified, the sound recognized to be included by the user may be, for example, a sound of rain, a sound of a dog barking, or a sound of a human speech. Furthermore, the predetermined classification processing may be, for example, processing of classifying the sound time series to be classified according to a place where the sound indicated by the sound time series to be classified is recorded. The place where the sound indicated by the sound time series to be classified is recorded may be, for example, a place inside a house, an airport, or a restaurant. Furthermore, the predetermined classification processing may be, for example, processing of classifying the sound time series to be classified according to characteristics of a speech included in the sound indicated by the sound time series to be classified. The characteristics of the speech may be, for example, the gender of the speaker, the age of the speaker, or the spoken language.

The sound estimation model acquisition device 1 may include a training network 10a instead of the training network 10. In such a case, a target to be updated by the update unit 104 is the training network 10a instead of the training network 10. The training network 10a is different from the training network 10 of the embodiment in including a classification network 105. The first sound time series, the second sound time series, the first difference information, the first sound event class label, and the second sound event class label are input to the training network 10a.

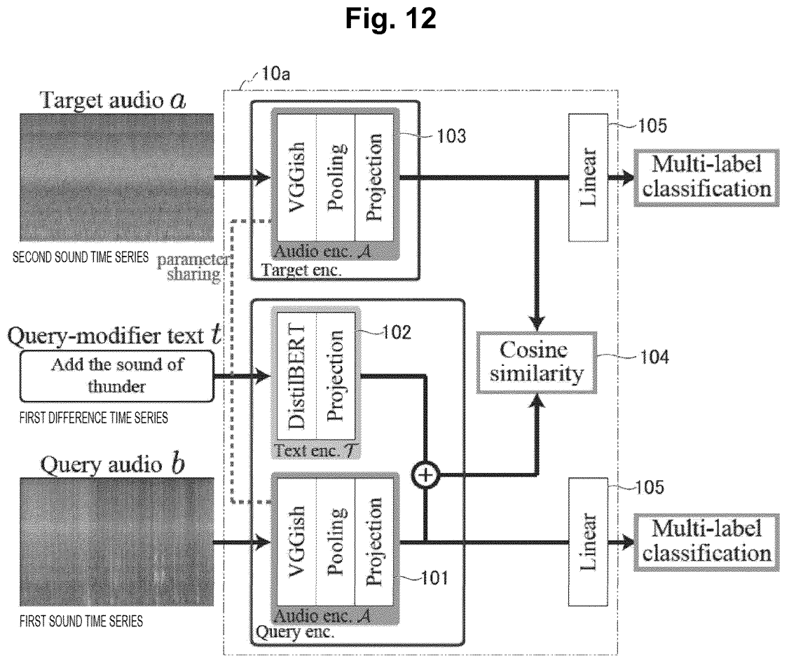

FIG. 12 is a diagram illustrating an example of a configuration of the training network 10a according to the modification example. The classification network 105 classifies the input information. The information input to the classification network 105 is the output of the first encoder 101 and the output of the third encoder 103. In the example of FIG. 12, the training network 10a includes two classification networks 105, and the output of the first encoder is input to one of the classification networks, and the output of the third encoder 103 is input to the other one of the classification networks.

Since the classification network 105 classifies the input information, the output of the classification network 105 in a case where the output of the first encoder 101 is input to the classification network 105 is an estimation result of the first sound event class label. The output of the classification network 105 in a case where the output of the third encoder 103 is input to the classification network 105 is an estimation result of the second sound event class label. The classification network 105 is updated when the training network 10a is updated by the update unit 104.

The update unit 104 that updates the training network 10a updates the training network 10a by using a loss function including a first auxiliary loss function and a second auxiliary loss function. The first auxiliary loss function indicates a difference between the result of estimation of the classification network 105 to which the output of the first encoder 101 is input and the first sound event class label. The second auxiliary loss function indicates a difference between the result of estimation of the classification network 105 to which the output of the third encoder 103 is input and the second sound event class label.

A function representing the sum of a first sub-loss function and a second sub-loss function is, for example, a function represented by Expression (12) below.

[Math. 12]

L_{cl}=Σₙ(BCE(C(A(aₙ),vₙ)+BCE(C(A(bₙ)),wₙ)) (12)

BCE represents binary cross entropy. C(·) is a function representing estimation processing by the classification network 105. The update unit 104 that updates the training network 10a uses a loss function (hereinafter referred to as an “integrated loss function”) including a function representing the sum of the first sub-loss function and the second sub-loss function in addition to the loss function used by the training network 10 of Expression (10).

The update unit 104 that updates the training network 10a updates the training network 10a so as to reduce the integrated loss function. The integrated loss function is reduced, and thus the value of the first sub-loss function and the value of the second sub-loss function also decrease. Therefore, the update unit 104 that updates the training network 10a updates the training network 10a so as to decrease the value of the first sub-loss function and the value of the second sub-loss function.

Therefore, the integrated loss function is, for example, a loss function represented by Lₒᵥₑᵣₐₗₗ=L+λL_{cl}. Lₒᵥₑᵣₐₗₗ is the integrated loss function. λ is a weighting parameter. λ is a predetermined value determined in advance.

When the sound estimation model acquisition device 1 uses the training network 10a instead of the training network 10 in this manner, the vectors output from the first to third encoders have features corresponding to the “type of sound event having a difference”, and as a result, an effect of improving the estimation accuracy of the sound estimation device 2 is produced. That is, when the model acquisition unit 112 acquires the sound estimation model by using the first sound event class label and the second sound event class label in addition to the first sound time series, the second sound time series, and the first difference information, the vectors output from the first to third encoders have features corresponding to the “type of sound event having a difference”, and as a result, an effect of improving the estimation accuracy of the sound estimation device 2 is produced.

The sound estimation device 2 may estimate the estimation target by using the mathematical model obtained by the sound estimation model acquisition device 1 using the training network 10a instead of the training network 10.

Note that the sound estimation model acquisition device 1 and the sound estimation device 2 do not necessarily need to be mounted as different devices. The sound estimation model acquisition device 1 and the sound estimation device 2 may be implemented as, for example, one device or one system having both functions.

Furthermore, functional units included in each of the sound estimation model acquisition device 1 and the sound estimation device 2 may be implemented using a plurality of information processing devices communicably connected to each other via a network.

Note that each of the sound estimation model acquisition device 1 and the sound estimation device 2 may be implemented using a plurality of the information processing devices communicably connected to each other via the network. Note that all or some of the functions of each of the sound estimation model acquisition device 1 and the sound estimation device 2 may be implemented by using hardware such as an application specific integrated circuit (ASIC), a programmable logic device (PLD), or a field programmable gate array (FPGA). The program may be recorded on a computer-readable recording medium. The computer-readable recording medium is, for example, a portable medium such as a flexible disk, a magneto-optical disc, a ROM, or a CD-ROM, or a storage device such as a hard disk built in a computer system. The program may be transmitted via an electrical communication line.

Although the embodiment of this invention has been described in detail with reference to the drawings, specific configurations are not limited to this embodiment and include design and the like within a range without departing from the gist of this invention.

### REFERENCE SIGNS LIST

100 Sound estimation system
1 Sound estimation model acquisition device
2 Sound estimation device
11 Control unit
12 Input unit
13 Communication unit
14 Storage unit
15 output unit
111 Information acquisition unit
112 Model acquisition unit
113 Communication control unit
114 Storage control unit
115 Output control unit
21 Control unit
22 Input unit
23 Communication unit
24 Storage unit
25 output unit
211 Query acquisition unit
212 Estimation unit
213 Communication control unit
214 Storage control unit
215 Output control unit
91, 93 Processor
92, 94 Memory
10, 10a Training network
105 Classification network

1. A sound estimation model acquisition device comprising:
a processor; and
a storage medium having computer program instructions stored thereon, wherein the computer program instruction, when executed by the processor, perform processing of:
acquiring a mathematical model that estimates an estimated time series that is a time series satisfying a predetermined estimation condition from one or a plurality of time series on a basis of a first sound time series that is a time series indicating a first sound, a second sound time series that is a time series indicating a second sound, and first difference information indicating at least a partial difference between the first sound and the second sound,
wherein the mathematical model is a mathematical model that estimates the estimated time series on a basis of an input time series that is a time series indicating an input sound and second difference information that is information indicating at least a partial difference between the input time series and the estimated time series, and
the estimation condition is a condition that a difference between a difference from the input time series and a difference indicated by the second difference information is smaller than a predetermined difference.

2. The sound estimation model acquisition device according to claim 1,
wherein the first difference information and the second difference information are pieces of text data.

3. The sound estimation model acquisition device according to claim 1,
wherein the first difference information and the second difference information are pieces of image data.

4. A sound estimation device comprising:
a processor; and
a storage medium having computer program instructions stored thereon, wherein the computer program instruction, when executed by the processor, perform processing of:
acquiring query information including a sound time series that is a time series indicating a sound and second difference information indicating at least a partial difference between an estimated time series that is a time series satisfying a predetermined estimation condition and the sound time series; and
estimating a time series satisfying the estimation condition from one or a plurality of time series on a basis of the query information, by using a mathematical model acquired by a sound estimation model acquisition device comprising: a processor; and a storage medium having computer program instructions stored thereon, wherein the computer program instruction, when executed by the processor, perform processing of: acquiring the mathematical model that estimates a time series satisfying the estimation condition from one or a plurality of time series on a basis of a first sound time series that is a time series indicating a first sound, a second sound time series that is a time series indicating a second sound, and first difference information indicating at least a partial difference between the first sound and the second sound, the mathematical model being a mathematical model that estimates a time series satisfying the estimation condition on a basis of an input time series that is a time series indicating an input sound and second difference information that is information indicating at least a partial difference between the input time series and a time series satisfying the estimation condition, and the estimation condition being a condition that a difference between a difference from the input time series and a difference indicated by the second difference information is smaller than a predetermined difference.

5. A sound estimation model acquisition method comprising
acquiring a mathematical model that estimates an estimated time series that is a time series satisfying a predetermined estimation condition from one or a plurality of time series on a basis of a first sound time series that is a time series indicating a first sound, a second sound time series that is a time series indicating a second sound, and first difference information indicating at least a partial difference between the first sound and the second sound,
wherein the mathematical model is a mathematical model that estimates the estimated time series on a basis of an input time series that is a time series indicating an input sound and second difference information that is information indicating at least a partial difference between the input time series and the estimated time series, and
the estimation condition is a condition that a difference between a difference from the input time series and a difference indicated by the second difference information is smaller than a predetermined difference.

6. A sound estimation method comprising:
acquiring query information including a sound time series that is a time series indicating a sound and second difference information indicating at least a partial difference from an estimated time series that is a time series satisfying a predetermined estimation condition; and
estimating a time series satisfying the estimation condition from one or a plurality of time series on a basis of the query information acquired, by using a mathematical model acquired by a sound estimation model acquisition device comprising: a processor; and a storage medium having computer program instructions stored thereon, wherein the computer program instruction, when executed by the processor, perform processing of: acquiring the mathematical model that estimates a time series satisfying the estimation condition from one or a plurality of time series on a basis of a first sound time series that is a time series indicating a first sound, a second sound time series that is a time series indicating a second sound, and first difference information indicating at least a partial difference between the first sound and the second sound, the mathematical model being a mathematical model that estimates a time series satisfying the estimation condition on a basis of an input time series that is a time series indicating an input sound and second difference information that is information indicating at least a partial difference between the input time series and a time series satisfying the estimation condition, and the estimation condition being a condition that a difference between a difference from the input time series and a difference indicated by the second difference information is smaller than a predetermined difference.

7. A non-transitory computer readable medium which stores a program for causing a computer to function as the sound estimation model acquisition device according to claim 1.

8. A non-transitory computer readable medium which stores a program for causing a computer to function as the sound estimation device according to claim 4.

9. The sound estimation model acquisition device according to claim 1,
wherein the mathematical model is also acquired on a basis of a first sound event class label indicating a classification result of the first sound time series and a second sound event class label indicating a classification result of the second sound time series.

10. The sound estimation device according to claim 4,
wherein the mathematical model is also acquired on a basis of a first sound event class label indicating a classification result of the first sound time series and a second sound event class label indicating a classification result of the second sound time series.
